(19) United States
(12) Patent Application Publication
(10) Pub. No.: US 2017/0005344 A1
(43) Pub. Date: Jan. 5, 2017

(54) Bipolar Plate and Layer Structure on the Bipolar Plate

(71) Applicant: Bayerische Motoren Werke Aktiengesellschaft, Muenchen (DE)

(72) Inventors: Johannes SCHMID, Muenchen (DE); Stefan HAASE, Muenchen (DE)

(21) Appl. No.: 15/267,274

(22) Filed: Sep. 16, 2016

Related U.S. Application Data
(63) Continuation of application No. PCT/EP2015/057777, filed on Apr. 9, 2015.

(30) Foreign Application Priority Data
May 13, 2014 (DE) 10 2014 209 049.0

(51) Int. Cl. H01M 8/0228; H01M 8/0245; H01M 4/88; H01M 4/86; H01M 4/94

(52) U.S. Cl. CPC H01M 8/0228; H01M 4/8657; H01M 4/94; H01M 4/88; H01M 4/8828; H01M 4/8825; H01M 4/8896; H01M 8/0245

(57) ABSTRACT

A bipolar plate, has a base area and raised structures provided thereon. The raised structures each have a first region and a second region. The first region is designed to penetrate into a gas diffusion layer that is to be brought into contact with the bipolar plate and to increase the contact area between the bipolar plate and the gas diffusion layer. The second region is between the base area of the bipolar plate and the first region of the raised structures. The first region and/or the second region is/are of such a form and/or arrangement that the base area of the bipolar plate and the gas diffusion layer are kept apart.

### CROSS REFERENCE TO RELATED APPLICATIONS

This application is a continuation of PCT International Application No. PCT/EP2015/057777, filed Apr. 9, 2015, which claims priority under 35 U.S.C. §119 from German Patent Application No. 10 2014 209 049.0, filed May 13, 2014, the entire disclosures of which are herein expressly incorporated by reference.

### BACKGROUND AND SUMMARY OF THE INVENTION

The present invention relates to a bipolar plate and to a layer structure which has a gas diffusion layer and a bipolar plate, a contact area between the bipolar plate and the gas diffusion layer being increased.

Bipolar plates are employed in electrochemical cells, such as, for example, a fuel cell system, having a plurality of individual fuel cells combined to form a stack. Bipolar plates have the task of separating the individual cells from one another, of providing an electrical contact between the electrodes of the electrochemical cells, of conducting current to adjacent cells, of supplying cells with media or reaction educts, and of dissipating the waste heat which forms.

A bipolar plate is usually in contact with a gas diffusion layer, which, in an electrochemical cell, serves as a distributor structure for the reaction educts, i.e. in particular the reaction gases, and is usually formed from woven fabrics composed of carbon materials. The bipolar plates are conventionally formed from metals, and therefore the electrical contact with the gas diffusion layer is not ideal. This produces a high contact resistance. By pressing the bipolar plate and the gas diffusion layer together, the contact resistance between the two layers can be reduced slightly, but for this purpose the bipolar plate generally has to be embossed in order to provide flow fields for the reaction educts. This on the one hand increases the contact resistance in turn and, on the other hand, is a complex and costly process.

Proceeding from this prior art, it is therefore an object of the present invention to provide a bipolar plate which provides a large contact area with a gas diffusion layer to be contacted and, moreover, flow fields for reaction media. Furthermore, it is an object of the invention to provide a layer structure comprising a bipolar plate and a gas diffusion layer which is distinguished by a low contact resistance between the layers and permits optimum transportation of reaction media.

In the case of a bipolar plate, the object is achieved according to the invention in that the bipolar plate comprises a base area and raised structures provided thereon. The raised structures, i.e. elevations with respect to the base area, each comprise a first region, which is designed to penetrate into a gas diffusion layer to be brought into contact with the bipolar plate. This increases a contact area between the bipolar plate and the gas diffusion layer and reduces a contact resistance between these layers. The raised structures furthermore each comprise a second region, which is present between the base area of the bipolar plate and the first region of the raised structures. The first and/or second regions are designed here in form and/or arrangement in such a way that the base area of the bipolar plate and the gas diffusion layer are kept at a spacing (X). The spacing (X) in this case can also be set when pressing the bipolar plate together with a gas diffusion layer, for example.

The form, arrangement, structure and material of the raised structures are not limited in detail, as long as they allow for a very good contact and the penetration of the first regions into the gas diffusion layer, with the contact area between the layers being increased, and the formation of a spacing function by the second regions of the raised structures. These functions are provided, for example, by intersecting raised structures. A first region of the raised structures then lies above the points of intersection of the raised structures, i.e. at the end which is more remote from the base area of the bipolar plate.

According to the invention, these first regions of the raised structures penetrate into a gas diffusion layer to be contacted. However, the points of intersection effectively prevent the raised structures from sinking completely into the gas diffusion layer. A region free from the gas diffusion layer, a spacing region, is formed beneath the points of intersection, i.e. between the points of intersection and the base area of the bipolar plate, and serves for the transportation of reaction media and therefore allows for effective conveying of these media by virtue of the spacing (X) which forms.

As an alternative or in addition to intersecting raised structures, the first and/or second regions can also be configured with a specific structure, which allows for the penetration only of the first regions of the raised structures into a gas diffusion layer that comes into contact, but prevents further penetration of the second regions. The spacing (X) is in this case determined proceeding from the base area of the bipolar plate in an orthogonal direction, i.e. in a laminating direction of a gas diffusion layer to be contacted, as far as the most remote point of the second regions of the raised structures, i.e. the point at which the first regions adjoin. This provides a bipolar plate having very good transportation paths for reaction media, i.e. an optimally integrated flow field and also an enlarged contact area, which allows for connection to a gas diffusion layer with reduced contact resistance in a simple manner. The bipolar plate according to the invention is suitable in particular for use in a fuel cell, the fuel cell being arranged in particular in a vehicle.

One advantageous development of the bipolar plate according to the invention provides that the spacing (X) corresponds substantially to a height of the second region of the raised structures. It is thereby easily possible, by virtue of the targeted configuration of the structure and form of the raised structures, to have a considerable influence on the media flow field to be formed, without it being necessary to take separate processing steps, such as, for example, embossing of the bipolar plate.

In order to provide a bipolar plate having a flow field with a large transportation volume, provision is further advantageously made for the spacing (X) to be 50 to 300 μm, preferably 70 to 150 μm.

It is further advantageous that the gas diffusion layer is fibrous or foam-like, and this makes good media transportation possible. A height of the first region of the raised structures is preferably 1 to 10 times, preferably 2 to 4 times, an average fiber diameter of the fibers or an average foam bubble diameter of the foam bubbles in the gas diffusion layer. This effectively increases the contact area between the bipolar plate and the gas diffusion layer and thereby considerably reduces contact resistance between said two layers.

Similarly for reasons of an increase in the contact area with a gas diffusion layer to be contacted and an associated reduction in contact resistance, a height of the first region of the raised structures is 3 to 100 μm, preferably 5 to 30 μm. The height of the first region therefore reflects a possible depth of penetration into a gas diffusion layer, which, at 5 μm, already provides a good bond with the gas diffusion layer with the contact resistance being reduced, the bond being optimum at a height of between 5 and 30 μm, since this also prevents deformation of the raised regions when the bipolar plate is brought into contact with the gas diffusion layer and facilitates penetration of the first regions into the gas diffusion layer. The height of the first region is determined along a direction of extent of the first region and represents an average value.

It is further advantageously provided that a width of a root of the raised structures which is connected to the base area of the bipolar plate is smaller than twice the overall height of the raised structures. The overall height here is given by the sum of the height h1 of the first regions and the height h2 of the second regions of the raised structures. In this respect, reference is made in each case to average values of the width and of the height. This achieves a very good volume/surface ratio in the raised structures, and this allows for the formation of a particularly large contact area with the lowest possible expenditure for material for the raised structures.

It is further advantageous that a spacing between raised structures arranged in a row at the respective highest point thereof is greater than twice the overall height of the raised structures. This makes it possible to achieve a good bond between the bipolar plate and the gas diffusion layer with a large contact area and little use of material.

As an alternative or in addition thereto, it is advantageously provided that a spacing between raised structures in adjacent rows at the respective highest point thereof satisfies the following relationship in relation to a spacing between raised structures arranged in a row at the respective highest point thereof: e/f>2. This, too, provides a very good contact area of the bipolar plate, and this allows for close contact with a gas diffusion layer with little contact resistance.

Raised structures comprising first and second regions which allow both for contacting and penetration into a gas diffusion layer and also for a gas diffusion layer to be kept at a spacing can be formed very easily by applying an intermediate layer between the bipolar plate base area and a gas diffusion layer to be contacted. This furthermore has the advantage that the intermediate layer and therefore the raised structures can be coordinated in a particularly targeted manner in terms of form, arrangement and structure with respect to the gas diffusion layer to be brought into contact. For this reason, it is particularly preferable to provide a foam-like intermediate layer and, in particular, an intermediate layer composed of individual structures to form the raised structures on the base area of the bipolar plate.

For reasons of simple and cost-effective production, with material costs being saved, the raised structures are advantageously formed by structurally processing the bipolar plate, in particular by coating with material, the deposition of material and/or the growth of material. It is thereby possible for the conductivity to be further improved in the transition between the first region of the raised structures and the gas diffusion layer provided for contact and for the contact resistance between the two layers to be effectively reduced. The structural processing advantageously comprises grinding, milling, scratching, etching, oxidizing, PVD, CVD and/or the growth of dendritic structures. The methods mentioned here are standard methods for processing surfaces, and in particular metallic surfaces, which do not require a high technical outlay and therefore can be implemented easily and cost-effectively and allow for the raised structures of the bipolar plate to be configured specifically.

It is further advantageous that the intermediate layer is connected to the base area of the bipolar plate h adhesive bonding, soldering, brazing, by being pressed on or by being pressed in. Depending on requirements, these method steps can also be combined with one another, this contributing to an increase in the contact area between the bipolar plate and a gas diffusion layer to be brought into contact therewith.

To reduce production costs for the bipolar plate according to the invention, it is free from embossed formations to provide flow fields. The function of the flow fields is taken on by the spacing (X) which is observed between the base area of the bipolar plate and the gas diffusion layer; an embossed formation in the active region of the bipolar plate can therefore be dispensed with.

The invention likewise also describes a layer structure which comprises a bipolar plate as described above and a gas diffusion layer. The layer structure according to the invention is characterized in that the first region of the raised structures of the bipolar plate has penetrated into the gas diffusion layer and increases a contact area between the bipolar plate and the gas diffusion layer. Furthermore, a form and/or arrangement of the first region and/or of the second region of the raised structures of the bipolar plate is designed in such a way that the base area of the bipolar plate and the gas diffusion layer are kept at a spacing (X). The layer structure according to the invention has a simple design structure combined with a high degree of functionality, with a contact resistance between the individual layers being reduced, At the same time, the formation and retention of the spacing provide media flow fields without the bipolar plate having to be processed separately for this purpose. The bipolar plate is therefore particularly readily suited for assembly in a fuel cell system. In particular, the spacing (X) can be set in a targeted manner when pressing the bipolar plate according to the invention and the gas diffusion layer together. For this purpose, the form or arrangement of the first region and/or of the second region of the raised structures is designed to penetrate into the gas diffusion layer. As a result of a predefined pressure, the raised structures penetrate to the desired extent, and therefore first regions of the raised structures are arranged in the gas diffusion layer, while second regions of the raised structures do not penetrate into the raised regions, and therefore the base area of the bipolar plate and the gas diffusion layer are kept at a spacing (X), which then reflects the height of the second regions of the raised structures. In other words, as a whole it is preferable that the form, embodiment and arrangement of the raised regions together with the contact pressure determine the desired spacing (X).

The advantages, advantageous effects and developments provided for the bipolar plate according to the invention are also applicable to the layer structure according to the invention.

To further reduce the contact resistance between the individual layers, one advantageous development of the layer structure according to the invention provides that the gas diffusion layer is fibrous or foam-like, a depth of penetration of the first region of the raised structures into the gas diffusion layer being 1-10 times, preferably 2-4 times, an average fiber diameter of the fibers or an average foam bubble diameter of the foam bubbles in the gas diffusion layer.

With respect to the aspect of increasing the contact area and therefore reducing the contact resistance, it is further advantageously provided that the material of the gas diffusion layer is compacted in a region of contact between the bipolar plate and the gas diffusion layer.

A further advantageous development is characterized in that the gas diffusion layer is fibrous or foam-like, the spacing (X) satisfying the following relationship: X≧5*d, where d is an average fiber diameter of the fibers or an average foam bubble diameter of the foam bubbles in the gas diffusion layer. It is thereby possible to provide a media flow field with a large transportation volume combined with a minimal use of material and at the same time a very good electrical conductivity, and this has a beneficial effect on the cost structure of the layer structure.

It is particularly advantageous with respect to the aspect of providing a flow field with a large transportation volume combined with a high stability of the layer structure and a reduced pressure loss that the spacing (X) is 50 to 300 μm and preferably 70 to 150 μm.

The bipolar plate according to the invention and the layer structure according to the invention are suitable in particular for use in a fuel cell, the fuel cell being arranged in particular in a vehicle.

On account of the solutions according to the invention and the developments thereof the following advantages are obtained:

a) the contact area between the bipolar plate according to the invention and a gas diffusion layer is increased considerably;

b) the contact resistance between the bipolar plate according to the invention and a gas diffusion layer is reduced;

c) The electrical conductivity between the bipolar plate according to the invention and a gas diffusion layer is increased; and

d) flow fields are integrated in the bipolar plate according to the invention without it being necessary for separate processing steps to be provided.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic illustration of a bipolar plate according to a first advantageous development of the invention.

FIG. 2 shows a schematic illustration of a bipolar plate according to a second advantageous development of the invention.

FIG. 3 shows a schematic illustration of a bipolar plate according to a third advantageous development of the invention.

FIG. 4 shows a schematic illustration of a bipolar plate according to a fourth advantageous development of the invention.

FIG. 5 shows a schematic illustration of a layer structure according to a first development of the invention.

FIG. 6 shows a schematic illustration of a layer structure according to a second development of the invention.

FIG. 7 shows a schematic illustration of a layer structure according to a third development of the invention.

### DETAILED DESCRIPTION OF THE DRAWINGS

The invention will be described in detail on the basis of exemplary embodiments. The figures show only those parts of the bipolar plate according to the invention or of the layer structure which are of interest here; all other elements have been omitted for the sake of clarity. Furthermore, identical reference signs refer to identical components.

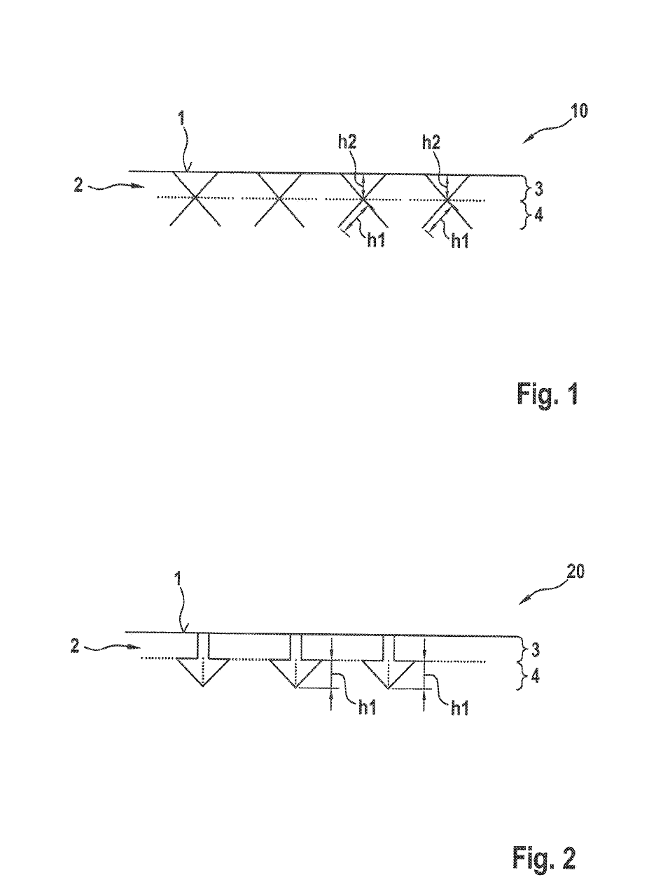

FIG. 1 shows a bipolar plate 10 comprising a base area 1 on which raised structures 2 are arranged or provided. The raised structures 2 each comprise a first region 4. The first region(s) 4 is or are designed to penetrate into a gas diffusion layer (not shown) to he brought into contact with the bipolar plate 10. This increases a contact area between the bipolar plate 10 and the gas diffusion layer. The raised structures 2 furthermore comprise second regions 3, which extend between the base area 1 of the bipolar plate 10 and the first regions 4 of the raised structures 2.

The arrangement of the first region 4 and of the second region 3, and therefore the arrangement of the raised structures 2 in relation to one another, is configured in such a way that the base area 1 of the bipolar plate 10 and a gas diffusion layer to be brought into contact with the bipolar plate are kept at a spacing. As is shown by way of example in FIG. 1, this is made possible by virtue of the fact that first and second regions of for example, adjacent raised structures 2 intersect. Thus, at least two intersecting structures give rise to a raised structure 2 which above the point of intersection has a first region 4 with a height h1 and below the point of intersection has a second region 3 with a height h2. When the bipolar plate 10 is being brought into contact with a gas diffusion layer, the extent of the intersecting structures prevents the complete penetration of the latter with the raised structures 2. The gas diffusion layer is thereby kept at a spacing which corresponds here, for example, to the height h2 of the second regions.

The height h2 of the second regions is in this case measured in a direction orthogonal to the base area 1 of the bipolar plate 10 and extends as far as the point of intersection of the raised structures 2. The height h1 of the first regions is determined in the direction of extent from the point of intersection as far as the end of the first region, i.e. the end which is provided to penetrate into a gas diffusion layer. The respective values relating to the heights are average values here.

It is preferable that a spacing X, and therefore also a height h2 of the second regions 3, is 50 to 300 μm and preferably 70 to 150 μm.

The raised structures 2 can be formed, for example, by applying an intermediate layer and, in particular, a foam-like intermediate layer and further in particular an intermediate layer composed of individual structures to the base area 1 of the bipolar plate 10. As an alternative thereto, the raised structures 2 can be formed by structurally processing the bipolar plate 10, in particular by coating with material, the deposition of material and/or the growth of material.

On account of the formation of the raised structures 2, the bipolar plate 10 provides a large potential contact area. Furthermore, on account of the second regions 3 of the raised structures 2, which are provided not to penetrate into the gas diffusion layer, provision is made of a media flow field in the bipolar plate 10 without the bipolar plate 10 having embossed formations in the active region for this purpose.

FIG. 2 shows an alternative configuration of a bipolar plate. The bipolar plate 20 again comprises a base area 1 with arrow-shaped raised structures 2 arranged thereon. The first regions 4 designed in arrowhead form facilitate penetration into a gas diffusion layer to be contacted, with the contact area being increased and therefore with the contact resistance being reduced. However, the wide legs of the arrowheads of the first regions 4 prevent penetration into a gas diffusion layer as far as the base area 1 of the bipolar plate 20, i.e. including the second regions 3. The second regions 3 thereby ensure that there is a spacing between the base area 1 of the bipolar plate 20 and a gas diffusion layer to be contacted.

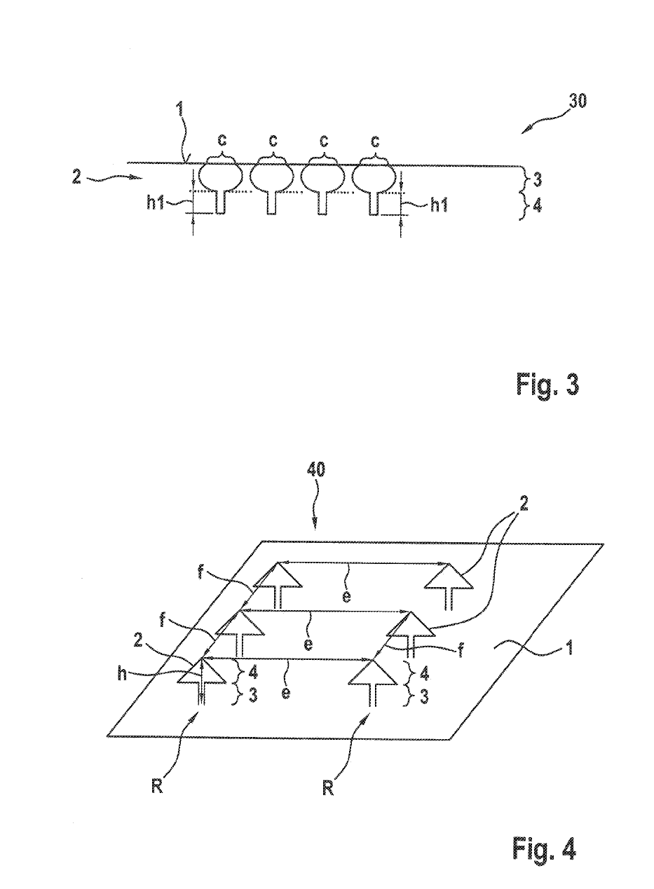

FIG. 3 shows a further alternative configuration of a bipolar plate. The bipolar plate 30 comprises raised structures 2, which in turn have first regions 4 and second regions 3. Here, the form or the structure of the first regions 4 is designed in elation to the form and structure of the second regions 3 in such a way that penetration of the first regions 4 into a gas diffusion layer to be contacted is possible only up to the point of the raised structures 2 at which the second region 3 is designed in thickened form with respect to the first region 4.

The material and structure of the second regions 3 do not have to be solid, but instead may be porous or may be provided with passages, such that a flow field with a large media volume can be provided. c denotes a root of the raised regions 2 which is connected to the bipolar plate 30. A width of a root of the raised structures c which is connected to the base area of the bipolar plate 1 is in this case advantageously smaller than twice the overall height of the raised structures 2.

FIG. 4 shows a bipolar plate 40 having raised structures 2 arranged in two rows R, as have already been explained in FIG. 2. FIG. 4 illustrates the relationship between the raised regions 2. In this case, a spacing f between raised structures arranged in a row R at the respective highest point thereof is greater than twice the overall height h of the raised structures 2, where h=h1+h2. Furthermore, a spacing e between raised structures 2 in adjacent rows at the respective highest point thereof advantageously satisfies the following relationship in relation to a spacing f between raised structures 2 arranged in a row at the respective highest point thereof e/f>2.

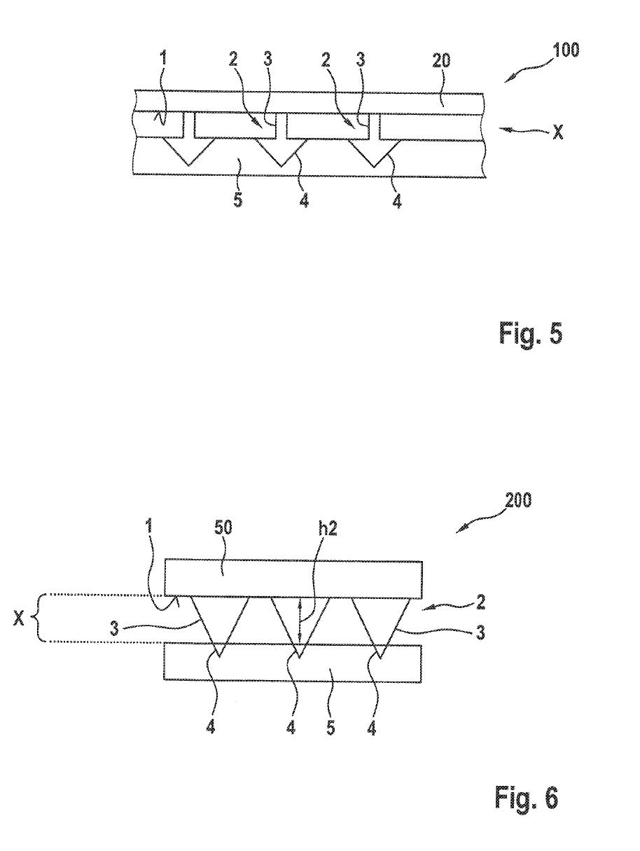

FIG. 5 shows a layer structure 100 according to one development of the invention. The layer structure 100 is formed from a gas diffusion layer 5 and a bipolar plate 20 as shown in FIG. 2. The gas diffusion layer 5 and the bipolar plate 20 have been pressed together to produce the layer structure 100. As a result of this, the first regions 4 of the raised structures 2 penetrate into the surface of the gas diffusion layer 5. On account of the form or the structure of the first regions 4 and of the second regions 3, the second regions 3 have been prevented from sinking into the gas diffusion layer 5. A spacing X is thus formed between the gas diffusion layer 5 and the base area 1 of the bipolar plate 20, said spacing having a height which corresponds to the height of the second regions 3. A media flow field has been formed as a result of this. The layer structure 100 is distinguished by a low contact resistance and good suitability for conveying reaction media.

The gas diffusion layer is preferably fibrous or foam-like, and the spacing X satisfies the following relationship: X≧5*d. Here, d is an average fiber diameter of the fibers or an average foam bubble diameter of the foam bubbles in the gas diffusion layer 5.

Furthermore, the spacing X is preferably 50 to 300 μm and preferably 70 to 150 μm.

It is likewise preferable that a height hi of the first regions 4 of the raised structures 2 is 1-10 times, preferably 2-4 times, an average fiber diameter of the fibers or an average foam bubble diameter of the foam bubbles in the gas diffusion layer 5, the height h1 of the first regions 4 of the raised structures 2 being in particular 3 to 100 μm, preferably 5 to 30 μm.

FIG. 6 shows a layer structure 200 according to a second development of the invention. The layer structure 200 has been produced by pressing a bipolar plate 50 together with a gas diffusion layer 5. The bipolar plate 50 comprises pyramidal raised structures 2 each having a first region 4 and a second region 3. The first regions 4 of the raised structures 2 have penetrated into the gas diffusion layer 5 by virtue of an appropriate pressure when pressing the layers together. The form, design and arrangement of the raised regions, together with the contact pressure, give the desired spacing X. By limiting the pressure, in this case it is possible to prevent the raised structures 2 from penetrating further into the gas diffusion layer 5. It is therefore the case, as shown here, that second regions 3 of the raised structures 2 are exposed between the base area of the bipolar plate 1 and the first regions 4 of the raised structures 2, i.e. also between the base area of the bipolar plate 1 and the gas diffusion layer 5, this resulting in a spacing X between the base area of the bipolar plate 1 and the gas diffusion layer 5 which is suitable for forming a media flow field.

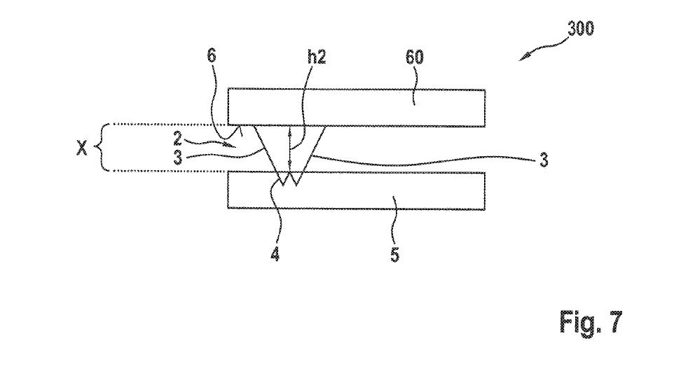

FIG. 7 shows a layer structure 300 according to a third development of the invention. The layer structure 300 differs from the layer structure 200 shown in FIG. 6 in terms of the form of the raised structure 2. The specific, M-shaped form offers a certain resistance, which, even when pressing the layer structure 300 together, prevents complete penetration of the raised structure 2 into the gas diffusion layer beyond the apex of the raised structure 2. By selecting the form of the raised region 2 in combination with the pressure when pressing the layer structure 300 together, it is thereby possible to set in a targeted manner a depth of penetration of the first region 4 of the raised structure 2, and therefore a certain spacing X, which corresponds to the height h2 of the second region 3 of the raised structure 2.

The above description of the present invention serves only for illustrative purposes and not for the purpose of limiting the invention. Various amendments and modifications are possible within the context of the invention without departing from the scope of the invention and the equivalents thereof.

### LIST OF REFERENCE SIGNS

1 Base area of the bipolar plate
2 Raised structures
3 Second regions of the raised structures
4 First regions of the raised structures
5 Gas diffusion layer
10 Bipolar plate
20 Bipolar plate
30 Bipolar plate
40 Bipolar plate
50 Bipolar plate
60 Bipolar plate
100 Layer structure
200 Layer structure
300 Layer structure
c Root of a raised structure which is connected to the bipolar plate
e Spacing between raised structures in adjacent rows at the respective highest point thereof
f Spacing between raised structures arranged in a row at the respective highest point thereof
h1 Height of the first regions
h2 Height of the second regions
h Overall height of the raised structures
R Row of raised structures
X Spacing

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A bipolar plate, comprising:
a base area; and
raised structures provided on the base area, wherein
the raised structures each comprise a first region, which is designed to penetrate into a gas diffusion layer to be brought into contact with the bipolar plate and to increase a contact area between the bipolar plate and the gas diffusion layer, and a second region, which is present between the base area of the bipolar plate and the first region of the raised structures, and
the first region and/or the second region are formed and/or arranged to keep the base area of the bipolar plate and the gas diffusion layer at a spacing (X).

2. The bipolar plate according to claim 1, wherein the spacing (X) corresponds substantially to a height of the second region of the raised structures.

3. The bipolar plate according to claim 1, wherein the spacing (X) is 50 to 300 μm.

4. The bipolar plate according to claim 1, wherein the spacing (X) is 70 to 150 μm.

5. The bipolar plate according to claim 1, wherein:
the gas diffusion layer is fibrous or foam-like,
a height of the first region of the raised structures is 1-10 times an average fiber diameter of the fibers or an average foam bubble diameter of the foam bubbles in the gas diffusion layer, or
a height of the first region of the raised structures is 3 to 100 μm.

6. The bipolar plate according to claim 5, wherein the height of the first region is 2-4 times the average fiber diameter or the average foam bubble diameter.

7. The bipolar plate according to claim 5, rein the height of the first region is 5-30 μm.

8. The bipolar plate according to claim 1, wherein one or more of:
a width of a root (c) of the raised structures which is connected to the base area of the bipolar plate is smaller than twice the overall height of the raised structures,
a spacing (f) between raised structures arranged in a row at a respective highest point thereof is greater than twice the overall height of the raised structures, and/or
a spacing (e) between raised structures in adjacent rows at the respective highest point thereof satisfies the following relationship in relation to the spacing (f) between raised structures arranged in the row at the respective highest point thereof: e/f>2.

9. The bipolar plate according to claim 1, wherein:
the raised structures are formed by applying an intermediate layer to the base area of the bipolar plate, or
the raised structures are formed by structurally processing the bipolar plate.

10. The bipolar plate according to claim 9, wherein:
the intermediate layer is a foam intermediate layer or an intermediate layer composed of individual structures.

11. The bipolar plate according to claim 9, wherein the structural processing is one or more of: a coating with material, a deposition of material, or a growth of material.

12. The bipolar plate according to claim 9, wherein the intermediate layer is connected to the base area of the bipolar plate by one or more of: adhesive bonding, soldering, brazing, by being pressed on or by being pressed in.

13. The bipolar plate according to claim 1, wherein the bipolar plate is free from embossed formations in an active region to provide flow fields.

14. A layer structure, comprising:
a bipolar plate having a base area and raised structures provided on the base area;
a gas diffusion layer;
wherein the raised structures of the bipolar plate each comprise a first region designed to penetrate into the gas diffusion layer of the layer structure to increase contact area between the bipolar plate and the gas diffusion layer and a second region present between the base are of the bipolar plate and the first region, the first region and/or the second region of the raised structures being formed and/or arranged to maintain a spacing (X) between the base area and the gas diffusion layer.

15. The layer structure according to claim 14, wherein:
the gas diffusion layer is fibrous or foam-like, and
a depth of penetration of the first region of the raised structures into the gas diffusion layer is 1-10 times an average fiber diameter of fibers or an average foam bubble diameter of foam bubbles in the gas diffusion layer.

16. The layer structure according to claim 15, wherein material of the gas diffusion layer is compacted in a region of contact between the bipolar plate and the gas diffusion layer.

17. The layer structure according to claim 15, wherein the depth of penetration is 2-4 times.

18. The layer structure according to claim 14, wherein:
the gas diffusion layer is fibrous or foam-like, and
the spacing (X) satisfies the relationship:
X≧5*d, wherein
d is an average fiber diameter of fibers or an average foam bubble diameter of foam bubbles in the gas diffusion layer, and
the spacing (X) is 50-300 μm.

19. The layer structure according to claim 18, wherein the spacing (X) is 70-100 μm.
